(19) United States
(12) Patent Application Publication
(10) Pub. No.: US 2003/0041698 A1
(43) Pub. Date: Mar. 6, 2003

(54) Magnetic engaging member for engaged with a socket

(76) Inventor: Yuan-Ching Chi, (US)

Correspondence Address: Charles E. Baxley, Esquire, 5th Floor, 59 John Street, New York, NY, 10038, US

(21) Appl. No.: 09/943,294

(22) Filed: Aug. 31, 2001

(51) Int. Cl. B25B 13/02

(52) U.S. Cl. 81/125

(57) ABSTRACT

An engaging member of a ratchet tool includes a polygonal section for being connected to a socket. A receiving section extends from said polygonal section and a carry member is movably received in said receiving section. A spring is engaged between said carry member and an inside of said receiving section. A first end of said carry member extends from an opening of said receiving section and a magnet is connected to said first end of said carry member. The position of the magnet is automatically adjusted to reach the bolt by the spring.

### FIELD OF THE INVENTION

The present invention relates to an engaging member on a ratchet tool for being engaged with a socket. The engaging member has a telescopic portion having a magnet connected thereto so as to be adhered with an object to be tightened or loosened.

### BACKGROUND OF THE INVENTION

A conventional engaging member 10 on a ratchet tool for being connected with a socket to tighten or loosen a bolt is shown in FIG. 1 and generally includes two polygonal sections 11 for being connected with sockets having different sizes. Each of the sections 11 has a bead 12 protruding from an outside thereof so as to let the socket securely mounted on the section 11. The socket is then mounted to a head of a bolt which is rotated with the rotation of the ratchet tool. However, when removing the ratchet from the position where the bolt is located, the socket is disengaged from the bolt so that the user has to pick the bolt up one by one. FIG. 2 shows that a magnet 14 is connected to an extension portion 13 of the engaging member 10 so that the bolt will be adhered on the magnet 14 when removing the ratchet tool. The position of the magnet 14 is fixed so that it could not reach the bolt if the length of the socket is too long. If the socket is too short, the central passage of the socket is occupied by the extension portion 13 and the bolt cannot be engaged with the socket.

### SUMMARY OF THE INVENTION

In accordance with one aspect of the present invention, there is provided an engaging member of a ratchet tool and the engaging member comprises a polygonal section and a bead extends from an outside of said polygonal section. A receiving section extends from said polygonal section and a carry member is movably received in said receiving section. A spring is engaged between said carry member and an inside of said receiving section. A first end of said carry member extends from an opening of said receiving section and a magnet is connected to said first end of said carry member.

The primary object of the present invention is to provide an engaging member that has a magnet movable connected to the engaging member so that the magnet reaches to the bolt regardless of the length of the socket.

The present invention will become more obvious from the following description when taken in connection with the accompanying drawings which show, for purposes of illustration only, preferred embodiments in accordance with the present invention.

### BRIEF DESCRIPTION OF THE DRAWINGS

FIG. 1 is a perspective view to show a conventional engaging member;

FIG. 2 is a perspective view to show another conventional engaging member;

FIG. 3 is an exploded view to show the engaging member of the present invention;

FIGS. 4 and 5 respectively show that the magnet of the engaging member of the present invention reaches to the bolts with different sizes;

FIG. 6 shows that the magnet of the engaging member of the present invention reaches to the bolt when cooperated with a short socket,

FIG. 7 is a cross sectional view to show another embodiment of the engaging member of the present invention;

FIG. 8 is yet another embodiment of the engaging member of the present invention;

FIG. 9 is another embodiment of the engaging member of the present invention, and

FIG. 10 shows that the engaging member of the present invention is connected to a universe joint.

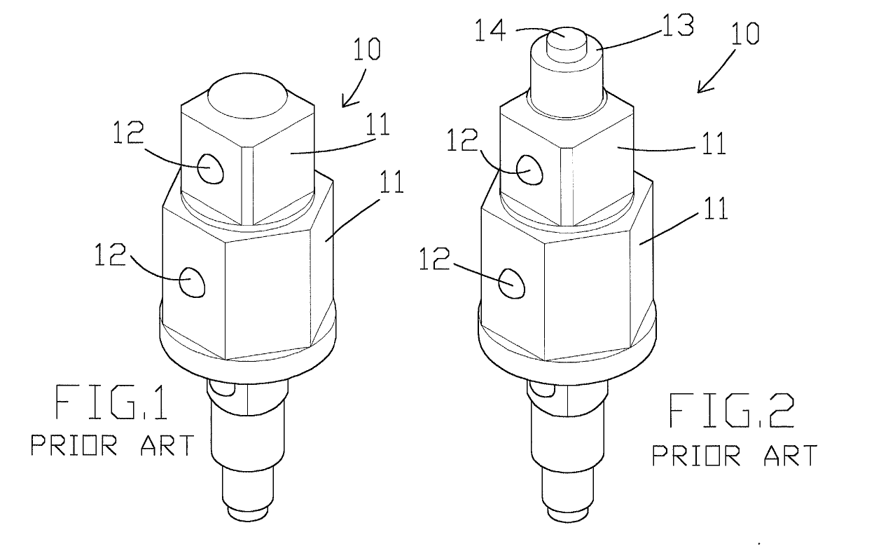

### DETAILED DESCRIPTION OF THE PREFERRED EMBODIMENTS

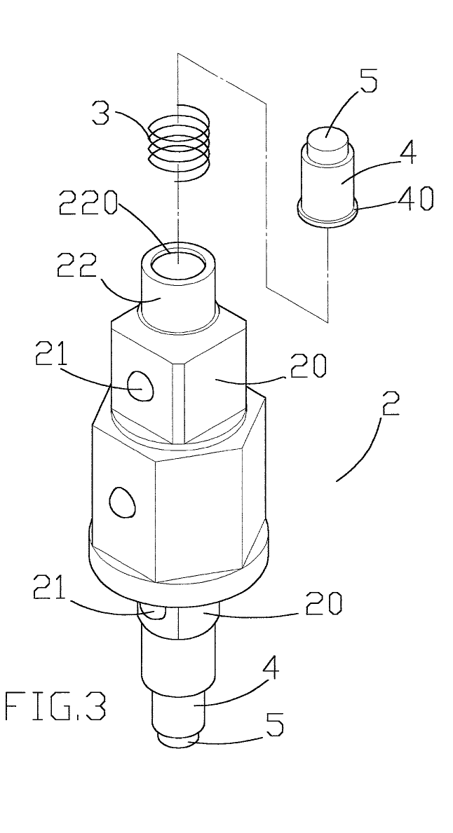

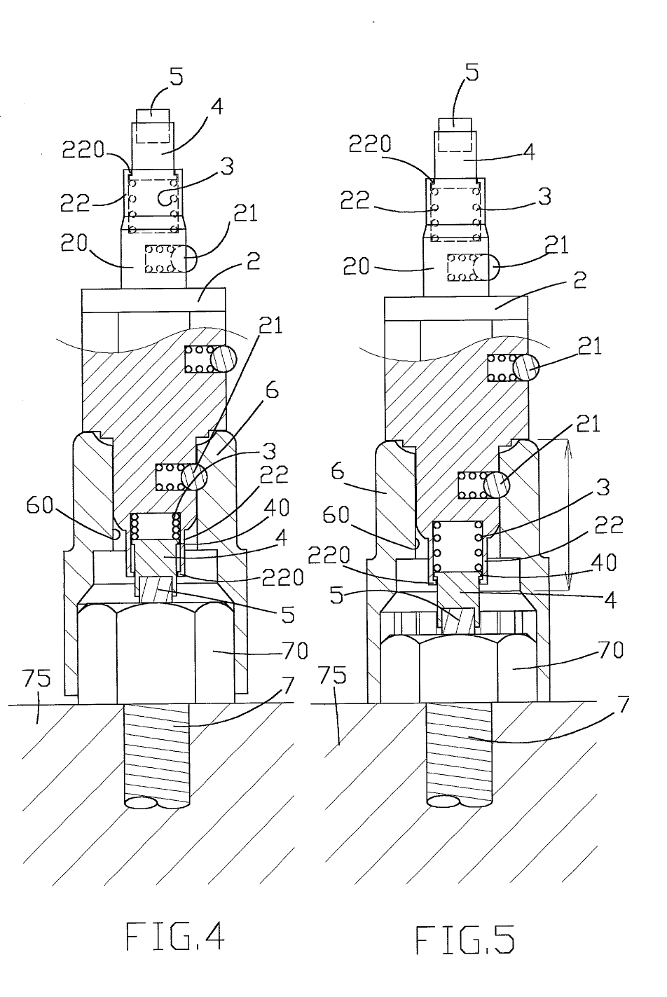

Referring to FIGS. 3 and 4, the engaging member for being connected to a ratchet tool of the present invention comprises two polygonal sections 20 and a bead 21 extends from an outside of each of said polygonal sections 20. A receiving section 22 extends from said polygonal section 20 and a carry member 4 is movably received in said receiving section 22. A spring 3 is engaged between said carry member 4 and an inside of said receiving section 22. A first flange 220 extends from an inner periphery of said opening of the receiving section 22 and a second flange 40 extends radially outward from a second end of said carry member 4. The diameter of the second flange 40 is larger than a diameter enclosed by the first flange 220 so that the second flange 40 is stopped by said first flange 220 to prevent said carry member 4 from disengaging from said opening of said receiving section 22. A first end of said carry member 4 extends from an opening of said receiving section 22 and a magnet 5 is connected to said first end of said carry member 4.

When a socket 6 is mounted to the polygonal section 20 and is positioned by the bead 21, the carry member 4 and the magnet 5 are located in the central passage 60 in the socket 6. When the socket 6 is mounted onto a head 70 of a bolt 7, the carry member 4 is pushed upward to compress the spring 3 and the magnet 5 is adhered to the head 70 of the bolt 7. Therefore, when the bolt 7 is completely loosened, the bolt 7 will still be adhered on the magnet 5 and is removed from the object 75 where the bolt 7 was engaged. FIG. 5 shows that when the thickness of the head 70 of the bolt 7 is thin, the socket 6 is pushed to touch the object 75 and the carry member 4 is pushed by the spring 3 and let the magnet 5 touch the head 70. FIG. 6 shows that if a short socket 6 is used, the carry member 4 is movably received in the receiving section 22 and the magnet 5 touches the head 70 of the bolt 7.

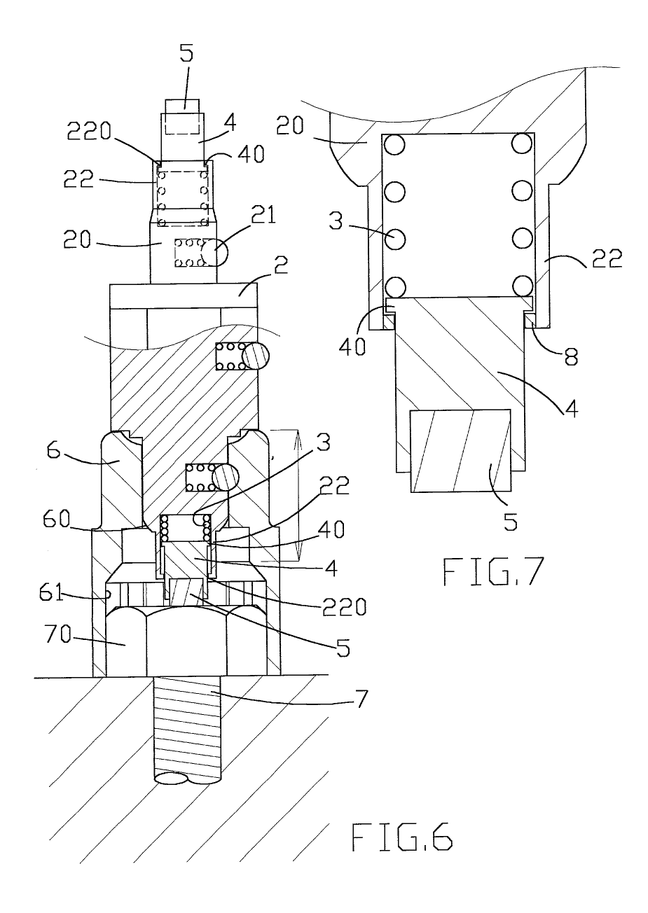

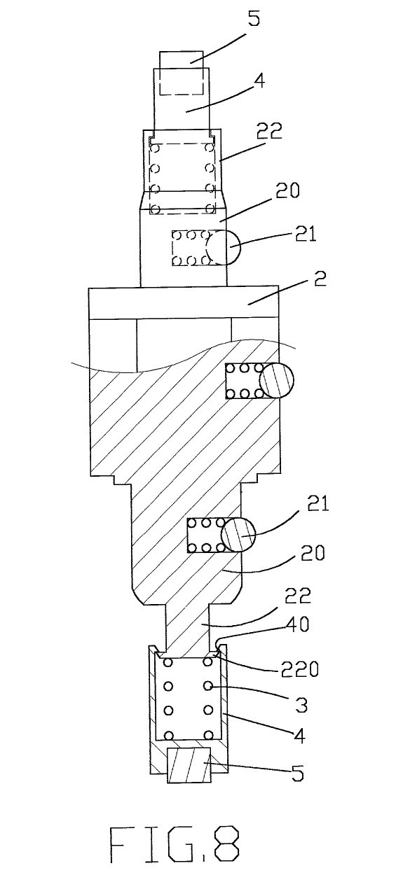

FIG. 7 shows that the first flange can be made by engaging a ring 8 with the inner periphery of the opening of the receiving section 22.

FIG. 8 shows another embodiment of the engaging member of the present invention and includes a polygonal section 20 and a bead 21 extends from an outside of said polygonal section 20. A protrusion section 22 extends from said polygonal section 20 and a carry member 4 is movably mounted to said protrusion section 22. A spring 3 is engaged between a distal end of said protrusion section 22 and an inside of said carry member 4. A magnet 5 is connected to said carry member 4. A first flange 220 extends radially outward from an outer periphery of said distal end of said protrusion section 22. A second flange 40 extends radially inward from an opening of said carry member 4 so that said second flange 40 will be stopped by said first flange 220 to prevent said carry member 4 from disengaging from said protrusion section 22.

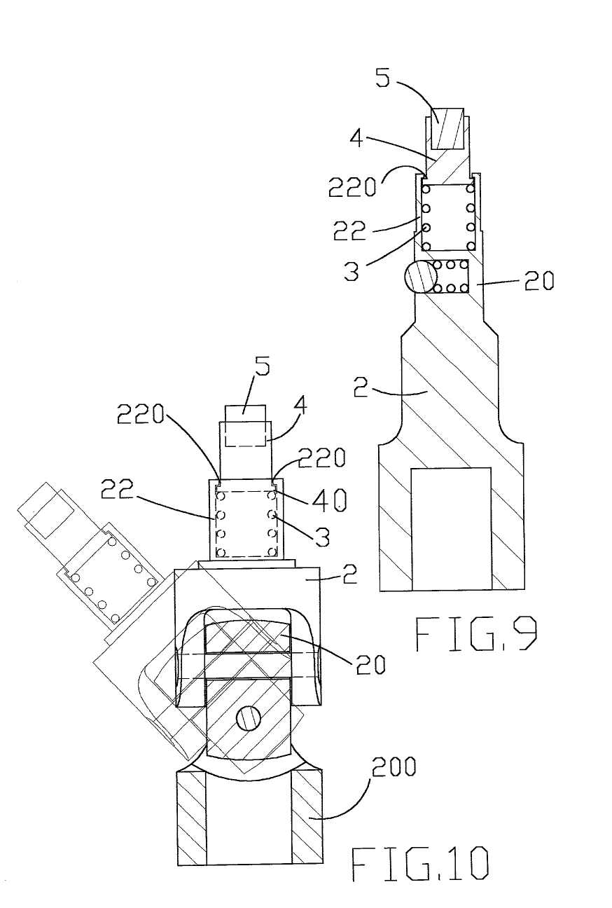

FIG. 9 shows that the engaging member 2 has an end having a recess for being engaged with other engaging member of tools. FIG. 10 shows that the engaging member 2 of the present invention is connected to a universe joint 200.

While we have shown and described the embodiment in accordance with the present invention, it should be clear to those skilled in the art that further embodiments may be made without departing from the scope of the present invention.

What is claimed is:

1. An engaging member of a ratchet tool, comprising:
a polygonal section and a bead extending from an outside of said polygonal section, a receiving section extending from said polygonal section, and
a carry member movably received in said receiving section, a first end of said carry member extending from an opening of said receiving section and a magnet connected to said first end of said carry member.

2. The engaging member as claimed in claim 1 further comprising a spring engaged between said carry member and an inside of said receiving section.

3. The engaging member as claimed in claim 1 further comprising a first flange extending from an inner periphery of said opening, a second flange extending radially outward from a second end of said carry member and being stopped by said first flange to prevent said carry member from disengaging from said opening of said receiving section.

4. An engaging member of a ratchet tool, comprising:
a polygonal section and a bead extending from an outside of said polygonal section, a protrusion section extending from said polygonal section, and
a carry member movably mounted to said protrusion section and a magnet connected to said carry member.

5. The engaging member as claimed in claim 4 further comprising a spring engaged between a distal end of said protrusion section and an inside of said carry member.

6. The engaging member as claimed in claim 5 further comprising a first flange extending radially outward from an outer periphery of said distal end of said protrusion section, a second flange extending radially inward from an opening of said carry member, said second flange being stopped by said first flange to prevent said carry member from disengaging from said protrusion section.
